(19) United States
(12) Patent Application Publication
(10) Pub. No.: US 2006/0072949 A1
(43) Pub. Date: Apr. 6, 2006

(54) Duplex-image reading apparatus and a method for using the same

(75) Inventor: Won-taek Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/236,625

(22) Filed: Sep. 28, 2005

(30) Foreign Application Priority Data
Oct. 4, 2004 (KR) 10-2004-0078728

(51) Int. Cl. G03G 15/00

(52) U.S. Cl. 399/374

(57) ABSTRACT

A duplex-image reading apparatus and a method for the same. The duplex-image reading apparatus comprises a document feeding path along which a document supplied from a document supply tray is passed through an image reading unit for an image reading operation and discharged to the outside of a main body of the duplex-image reading apparatus by a discharging roller, a document returning unit for returning a feeding direction of the document being discharged by the discharging roller, so that a rear end of the document becomes a leading end, a sensor mounted on the document feeding path to detect a length of the document, and at least two document returning paths having different lengths according to the length of the document detected by the sensor. Accordingly, generation of an unnecessary path can be restrained by varying the document returning path when returning the document according to the length of the document, and therefore image reading speed can be improved.

### CROSS-REFERENCE TO RELATED APPLICATIONS

This application claims benefit of Korean Patent Application No. 2004-78728, filed Oct. 4, 2004, in the Korean Intellectual Property Office, the disclosure of which is incorporated herein by reference.

### BACKGROUND OF THE INVENTION

1. Field of the Invention

The present invention relates to a duplex-image reading apparatus and a method for reading the duplex-image using the same. More particularly, the present invention relates to a duplex-image reading apparatus capable of improving image-reading speed by varying a path for returning a document toward an image-reading unit according to a length of the document, and a method for the same.

2. Description of the Related Art

An example of conventional duplex-image reading apparatuses is disclosed in Japanese Patent Laid-Open No. H9-307701 (laid open on Nov. 28, 1997, entitled “An image reading apparatus”).

In the exemplary conventional image reading apparatus, one face of a document that is being returned from a document supply tray to a first document feeder is read at a reading position by an image reading part. Additionally, after being returned by a second document feeder, the document takes a U-turn and passes through the reading position as being face-reversed, and accordingly the other face of the document is read. Then, the document is discharged through a document discharging part. A returning path for the second document feeder is formed longer than a document having a maximum size.

FIG. 1 schematically shows the operation of the conventional duplex-image reading apparatus 1.

In FIG. 1, a document 3 supplied from a document supply tray 2 is picked up by a pickup roller 5 and supplied to a document feeding path 7. The supplied document 3 is separated sheet by sheet as passing through an automatic document feeder (ADF) roller 9. A friction pad 11 provided in tight contact with the ADF 9 enables easy separation of the document 3. The document, separated sheet by sheet by the ADF roller 9, is transferred to an image reading unit 17 through first and second feeding rollers 13 and 15.

After one face of the document 3 has been transferred to the image reading unit and read, the document 3 is transferred to a discharging roller 21 by a third feeding roller 19 and discharged to the outside of a main body 23 of the apparatus by the discharging roller 21. Thus, simplex-image reading is completed.

In order to achieve duplex-image reading, after the one face is scanned as described above, a feeding direction of the document 3 is reversed so that a rear end of the document 3 then becomes a leading end before the document 3 is discharged through a discharge opening 23a of the main body 23. Then, the document 3 is transferred to a document returning path 25. A path conversion device 26 is formed near the document returning path 25 to selectively open the document returning path 25 or the document feeding path 7. The document 3 guided to the document returning path 25 is continuously fed to pass through a returning roller 27 and U-turned at the feeding roller 15, such that the face being read is reversed. Therefore, the image reading unit 17 reads the reversed face of the document 3, and thus, completing the duplex-image reading.

When performing the duplex-image reading as described above, an upper face of the document 3 being discharged to the outside of the main body 23 is reversed after performing the simplex-image reading. Therefore, in order to correct a posture of the document 3 being discharged, the document 3 is returned once again through the document returning path 25, U-turned by the second feeding roller 15 and then discharged.

Accordingly, for the duplex-image reading, the document 3 cycles threerounds of the document feeding path 7a which corresponds to a section B from a path conversion point S1 to an ending point E1 of the document returning path 25.

In order to enhance the image reading speed in the conventional duplex-image reading apparatus 1, (at a time point) when a rear end of a preceding document (hereinbelow, referred to as “first document”) gets out of a resist sensor 29, a following document (hereinbelow, referred to as “second document”) is picked up and kept in a standby mode, instead of getting into the first feeding roller 13. The second document is fed after completing duplex-image reading of the first document.

However, according to the above document feeding system, the rear end of the first document and a leading end of the second document may collide with each other near the path conversion point S1. To overcome this problem, the document feeding path 7a corresponding to the section B from the path conversion point S1 to the ending point E1 of the document returning path 25 is manufactured longer than a document of the maximum size (legal size 356 mm) in the conventional duplex-image reading apparatus 1.

According to this, when an A4-size (297 mm) document which is 58 mm shorter than the legal-size document is performed with the duplex-image reading, for example, an unnecessary feeding path is generated as much as 174 mm after the three-time round of the section B of the document 3.

Even in the Japanese Patent Laid-Open No. H9-307701 (laid open on Nov. 28, 1997, entitled “An image reading apparatus”), the second document feeder is set to be longer than the length of the maximum-size document, thereby causing an unnecessary feeding path.

### SUMMARY OF THE INVENTION

An aspect of the present invention is to solve at least the above problems and/or disadvantages and to provide at least the advantages described below. Accordingly, an aspect of the present invention is to provide a duplex-image reading apparatus capable of improving an image reading speed by varying a document returning path according to a length of the document, so that the document is returned through the document returning path corresponding to its length.

Another aspect of the present invention is to provide a method for duplex-image reading using the duplex-image reading apparatus.

In order to achieve the above-described aspects of the present invention, there is provided a duplex-image reading apparatus including a document feeding path along which a document supplied from a document supply tray is passed through an image reading unit for an image reading operation and discharged to the outside of a main body of the duplex-image reading apparatus by a discharging roller, a document returning unit for returning a feeding direction of the document being discharged by the discharging roller, so that a rear end of the document becomes a leading end, a sensor mounted on the document feeding path to detect a length of the document, and at least two document returning paths having different lengths according to the length of the document detected by the sensor.

The document returning paths are connected to first and second path conversion points, respectively, disposed on a downstream of the document feeding unit at a predetermined interval and connected to one ending point disposed on an upper stream of the image reading unit to take the document returned through the first and the second path conversion points.

The document returning unit includes a motor driven forward and backward, and a bi-directional roller rotated forward and backward by power of the motor and disposed at a downstream of the second path conversion point of the document returning path. The bi-directional roller may be a discharging roller.

A return sensor may be disposed at an upper stream of the path conversion point which is adjacent to the image reading unit to detect a leading end of the document and determine the time point for operating the document returning unit.

A path conversion device for converting the feeding direction of the document is further provided adjacent to the first and the second path conversion points.

The path conversion device includes a gate bar hinged by one end thereof and spontaneously pivoted down by its own weight to maintain an opened state of the first and the second document returning paths, and pivoted up by a document feeding force to thereby open the document feeding path when the document is being fed through the document feeding path. The path conversion device includes a gate bar electrically operated by a solenoid to selectively open and close the document returning path and the document feeding path.

The sensor for detecting the length of the document may be mounted on the document supply tray to detect the document in a still state or to detect the document being fed.

According to another aspect of the present invention, there is provided a method for duplex-image reading, including reading one face of a document fed through a document feeding path, obtaining information on a length of the document, reversing a document feeding direction by a document returning unit so that a rear end of the document, being discharged after the one surface is read by an image reading unit, becomes a leading end and returning the document to an upper stream of the image reading unit through a document returning path corresponding to a length of the document, and reading another face of the document as face-reversed.

The document returning path is determined by detecting the leading end of the document being fed to an upper stream of the document returning path and varying a time point for operating the document returning unit according to the length of the document based on the time point of detecting the leading end.

The document length is detected at positions on a document supply tray, where the document is always stacked regardless of the length thereof and where the document may be stacked or not stacked according to the length thereof, and when the document is detected at both of the positions, the document is determined to be long and when the document is detected at only one of the positions, the document is determined to be short.

The document length is detected by counting time of detecting the leading end and the rear end of the document being fed through the document feeding path.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating the structure of a conventional duplex-image reading apparatus;

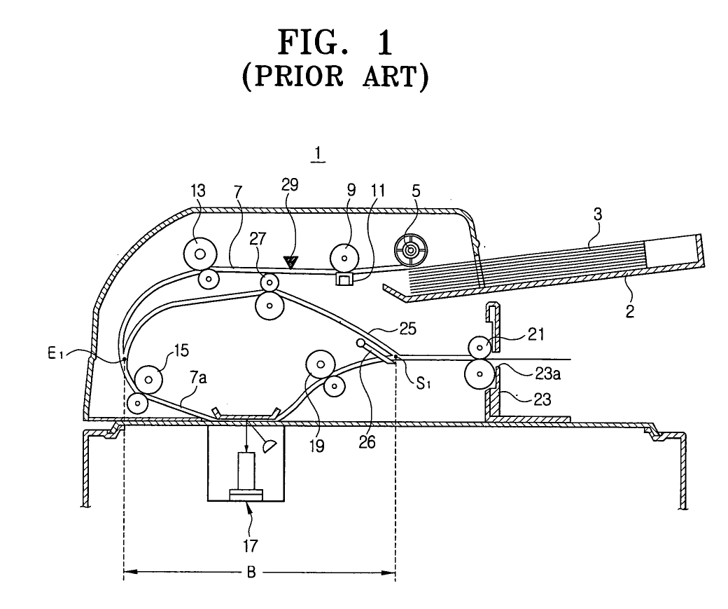

FIG. 2 is a view illustrating the structure of a duplex-image reading apparatus according to an embodiment of the present invention; and

FIG. 3 is a flowchart illustrating the processes of duplex-image reading, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

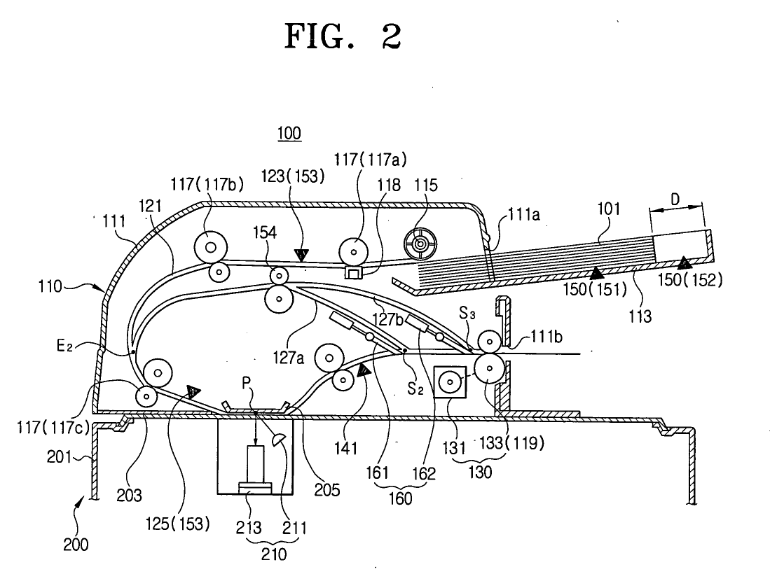

FIG. 2 schematically shows the structure of a duplex-image reading apparatus according to an embodiment of the present invention. The terms “upper stream” and “downstream” hereinbelow are determined on the basis of a feeding direction of a document 101.

In FIG. 2, a duplex-image reading apparatus 100 comprises a returning unit 110 for returning the document 101, and an image reading unit 200 for reading the document 101 being returned.

The returning unit 110 comprises a returning part body 111, a document supply tray 113 for stacking thereon the document 101 for image reading, a pickup roller 115 for picking up the document 101 stacked on the paper supply tray 113, a plurality of feeding rollers 117 (117a to 117c) for feeding the picked-up document 101 to an image reading unit 210 which will be described hereinbelow, and a discharging roller 119 for discharging the document 101 of which the image is read through the image reading unit 210.

The pickup roller 115, the feeding rollers 117 and the discharging roller 119 are arranged so that a document feeding path 121 forms a substantially laid U-shape to save a horizontal length of the returning part body 111. Accordingly, a supply opening 111a and a discharge opening 111b are almost vertically arranged.

The feeding rollers 117 comprises an automatic document feeder (ADF) roller 117a for separating the document picked up by the pickup roller 115 sheet by sheet, a resist roller 117b for compensating skew of the document 101 being fed by the ADF roller 117a by making a curl on the document 101 by rotating after suspending for a predetermined time, and a scan roller 117c mounted to a leading end of the image reading unit 210 to make a U-turn of the document 101. A friction pad 118 is formed in the face of the ADF roller 117 to provide friction for separating the document 101 sheet by sheet.

At an upper stream of the resist roller 117b, a resist sensor 123 is formed to detect the document 101 and determine a time point for starting rotation of the resist roller 117b. In addition, a scan sensor 125 is formed at a downstream of the scan roller 117c to detect the document 101 being fed and determine a time point for starting operation of the image reading unit 210.

Hereinbelow, the structure for returning the document 101 during the duplex-image reading will be described.

First and second document returning paths 127a and 127b are formed in a manner that first and second path conversion points S2 and S3 thereof are connected on a downstream of the document feeding path 121 with respect to the image reading unit 210 and an ending point E2 thereof is connected on an upper stream of the document feeding path 121 with respect to the image reading unit 210. According to the length of the document 101, the first and the second document returning paths 127a and 127b are formed in different lengths.

The first and the second document returning paths 127a and 127b may be configured in various ways. In this embodiment, however, the first and the second path conversion points S2 and S3 of the first and the second document returning paths 127a and 127b are disposed at a predetermined distance from each other. Also, the first and the second document returning paths 127a and 127b are converged at predetermined distances from the first and the second path conversion points S2 and S3, respectively, and ended at the same ending point E2.

The ending point E2 is disposed at an upper stream of the image reading unit 210, more preferably, at an upper stream of the scan roller 117c, such that the document 101 fed through the first and the second document returning paths 127a and 127b are U-turned by the scan roller 117c and supplied toward the image reading unit 210.

Furthermore, a document returning unit 130 is provided to reverse a feeding direction of the document 101 through the first and the second document returning paths 127a and 127b.

The rear end of the document 101 fed after the image thereof is read by the image reading unit 210 becomes a leading end of the document 101 by the document returning unit 130. To this end, the document returning unit 130 comprises a motor 131 driven forward and backward, and a bi-directional roller 133 rotated forward and backward by the power of the motor 131. Although the bi-directional roller 133 may be dedicatedly provided, the discharging roller 119 may also serve as the bi-directional roller 133, thereby reducing the number of parts and saving an assembling space. The power of the motor 131 is transmitted to the discharging roller 119 through a gear train (not shown).

Additionally, a return sensor 141 is formed in front of the second conversion point S2 of the first document returning path 127a to detect the leading end of the document 101 and determine the time point for operating the document returning unit 130.

In order to determine the operating time of the document returning unit 130, information on the length of the document 101 is necessitated. Therefore, a document sensor 150 for detecting the length of the document 101 is included.

The document sensor 150 comprises first and second document sensors 151 and 152 formed on the document supply tray 113. The scan sensor 125 formed on the document feeding path 121 may be used for a third document sensor 153.

When obtaining the information on the document length at the document supply tray 113, the first sensor 151 is disposed substantially in the middle of the document supply tray 113 and the second sensor 152 is disposed in a section D generated variably according to the length of the document 101.

More specifically, as the leading end of the document 101 is arranged, a position of the rear end of the document 101 varies according to the length of the document 101. Therefore, as shown in FIG. 2, when the document 101 is shorter than the document supply tray 113, a gap is generated between a rear end of the document supply tray 113 and the rear end of the document 101. The section D denotes the gap.

For example, the first and the second document sensors 151 and 152 may detect a pressed state of the stacked document 101 or check reception of light as an optical sensor having a light emitter and a light receiver.

When both the first and the second sensors 151 and 152 detect the document 101 simultaneously, the document 101 is determined to be long, that is, the legal size. When only the first sensor 151 detects the document 101, the document 101 is determined to be short, that is, the A4 size.

When using the third sensor 153 mounted on the document feeding path 121 to detect the length of the document, the third sensor 153 should actually measure the length of the document 101 from the leading end to the rear end. For example, the length of the document 101 can be calculated by the counting time of the third sensor being turned on and off while feeding the document 101. The resist sensor 123 or the scan sensor 125 may substitute for the third document sensor 153.

A path conversion device 160 for changing the document feeding direction is provided adjacent to the first and the second path conversion points S2 and S3 of the first and the second document returning paths 127a and 127b, respectively. As shown in FIG. 2, the path conversion device 160 comprises a gate bar 161 hinged by one end thereof. The gate bar 161 is spontaneously pivoted down by its own weight, thereby maintaining an opened state of the first and the second document returning paths 127a and 127b. When the document 101 is being fed through the document feeding path 121, the gate bar is pivoted up by a document feeding force, thereby opening the document feeding path 121.

Alternatively, the gate bar 161 may be electrically operated by a solenoid 162 to selectively open and close the first and the second document returning paths 127a and 127b and the document feeding path 121.

In the above structure, a returning roller 154 is additionally provided on the first and the second document returning paths 127a and 127b for smoother returning operation.

Hereinbelow, the structure of the image reading part 200 will be described in greater detail.

In the image reading part 200, a plate glass 203 made of a transparent material is disposed on an upper part of a reading part body 201, and the image reading unit 210 for reading an image of the document 101 is disposed at a predetermined position below the plate glass 203. Above the plate glass 203 which faces the image reading unit 210, a white bar 205 is provided to press the document 101 toward the image reading unit 210.

For example, the image reading unit 210 comprises a light generator 211 for irradiating a predetermined light onto the document 101 tightly contacted with an upper surface of the plate glass 203 by the white bar 205, and an optical sensor 213 for receiving the light irradiated by the light generator 211 and reflected from a reading position P as an image light, amplifying the image light input as an analog signal and converting the analog signal into a digital signal by an analog-digital (A-D) converter.

Hereinbelow, image reading processes by the duplex-image reading apparatus 100 will be described.

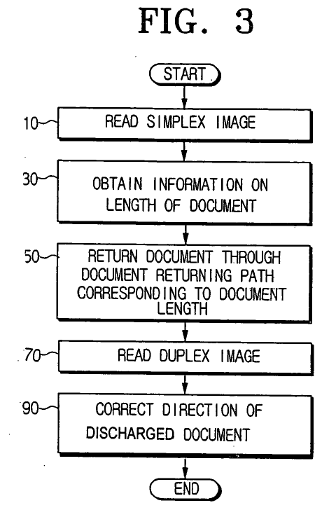

FIG. 3 is a flowchart illustrating the processes of duplex-image reading, according to an embodiment of the present invention.

In FIGS. 2 and 3, the pickup roller 115 rotates to pick up the document 101 stacked on the document supply tray 113 according to a simplex-image reading operation (operation 10). The document 101 picked up by the pickup roller 115 is separated sheet by sheet, passing through a space between the ADF roller 117a and the friction pad 118. The document 101 is continuously fed by the resist roller 117b, U-turned at the scan roller 117c and supplied to a space between the image reading unit 210 and the white bar 205. After one face of the document 101 is read, the document 101 is discharged to the outside of the main body 23 by the discharging roller 119, thus completing the simplex-image reading. The gate bar 161 of the path conversion device 160 is pivoted upward, being beaten by the document 101. The gate bar 161 may be electrically operated by the solenoid 162 so that a rotational direction of the gate bar 161 is changed. Accordingly, the document feeding path is converted.

During the simplex-image reading operation in operation 10, the length of the document 101 is detected (operation 30). The operation for detecting the document length is already described above.

In operation 50, for the duplex-image reading operation after the simplex-image reading, the document 101 being discharged by the discharging roller 119 is returned toward the image reading unit 210 through the returning path differently assigned according to the length thereof.

More specifically, the leading end of the document 101 fed after the simplex-image reading is detected by the return sensor 141. After a predetermined time of detection of the return sensor 141, the motor 131 is driven in the opposite direction to thereby rotate the discharging roller 119 in the opposite direction to a discharging direction.

The predetermined time is determined based on the information on the document length, which is obtained by the document sensor 150. In cases where the document 101 is relatively short, the discharging roller 119 is operated when the rear end of the document 101 located on the first path conversion point S2. In cases where the document 101 is relatively long, the discharging roller 119 is operated when the rear end of the document 101 is located on the second path conversion point S3. Thus, the document 101 is returned through different paths according to the length thereof.

The document 101 returned through the first or the second document returning path 127a or 127b is U-turned again at the scan roller 117c to be reversed so that the other face of the document 101 faces the image reading unit 210. Then, passing through a space between the white bar 205 and the image reading unit 210, the other face of the document 101 is read in operation 70.

Next, the document 101 is returned once again through the first and the second document returning paths 127a and 127b so as to correct a stacking posture of the document 101 being discharged, U-turned by the scan roller 117c, passed through a space between the image reading unit 210 and the white bar 205, and discharged through the discharge opening 111b by the discharging roller 119 in operation 90.

As can be appreciated from the above description, according to the duplex-image reading apparatus and the method thereof of the present invention, generation of an unnecessary path can be restrained when returning the document 101 for duplex-image reading, by varying the document returning path according to the length of the document 101, thereby saving time for the image reading.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A duplex-image reading apparatus comprising:
a document feeding path along which a document supplied from a document supply tray is passed through an image reading unit for an image reading operation and discharged to the outside of a main body of the duplex-image reading apparatus by a discharging roller;
a document returning unit to return a feeding direction of the document being discharged by the discharging roller, so that a rear end of the document becomes a leading end;
a sensor mounted on the document feeding path to detect a length of the document; and
at least two document returning paths having different lengths according to the length of the document detected by the sensor.

2. The duplex-image reading apparatus of claim 1, wherein the document returning paths are connected to first and second path conversion points, respectively, disposed on a downstream of the document feeding unit at a predetermined interval and connected to an ending point disposed on an upper stream of the image reading unit to take the document returned through the first and the second path conversion points.

3. The duplex-image reading apparatus of claim 1, wherein the document returning unit comprises a motor driven forward and backward, and a bi-directional roller rotated forward and backward by power of the motor and disposed at a downstream of the second path conversion point of the document returning path.

4. The duplex-image reading apparatus of claim 3, wherein the bi-directional roller is a discharging roller.

5. The duplex-image reading apparatus of claim 2, wherein a return sensor is disposed at an upper stream of the first path conversion point to detect a leading end of the document and to determine the time point for operating the document returning unit.

6. The duplex-image reading apparatus of claim 2, wherein a path conversion device to convert the feeding direction of the document is provided adjacent to the first and the second path conversion points.

7. The duplex-image reading apparatus of claim 6, wherein the path conversion device comprises a gate bar hinged by one end thereof and spontaneously pivoted down by its own weight to maintain an opened state of the first and the second document returning paths, and pivoted up by a document feeding force to thereby open the document feeding path when the document is being fed through the document feeding path.

8. The duplex-image reading apparatus of claim 6, wherein the path conversion device comprises a gate bar electrically operated by a solenoid to selectively open and close the document returning path and the document feeding path.

9. The duplex-image reading apparatus of claim 1, wherein the sensor for detecting the length of the document, comprises:
a first document sensor disposed on the document supply tray, especially at a position on which the document is located regardless of the length thereof; and
a second document sensor disposed on a rear part of the document supply tray, especially at a position on which the document is located or not located according to the length thereof.

10. The duplex-image reading apparatus of claim 1, wherein the sensor for detecting the length of the document comprises a third sensor mounted on the document feeding path to detect the length of the document based on time of being turned on and off thereof.

11. A method for duplex-image reading, comprising:
reading one face of a document fed through a document feeding path;
obtaining information on a length of the document;
reversing a document feeding direction by a document returning unit so that a rear end of the document, being discharged after the one surface is read by an image reading unit, becomes a leading end and returning the document to an upper stream of the image reading unit through a document returning path corresponding to a length of the document; and
reading another face of the document as face-reversed.

12. The method of claim 11, wherein the document returning path is determined by detecting the leading end of the document being fed to an upper stream of the document returning path and varying a time point for operating the document returning unit according to the length of the document based on the time point of detecting the leading end.

13. The method of claim 11, wherein the document length is detected at positions on a document supply tray, where the document is always stacked regardless of the length thereof and where the document is stacked or not stacked according to the length thereof, and when the document is detected at both of the positions, the document is determined to be long and when the document is detected only at the former position, the document is determined to be short.

14. The method of claim 11, wherein the document length is detected by counting time of detecting the leading end and the rear end of the document being fed through the document feeding path.

15. A method for duplex-image reading, comprising:
reading one face of a document;
obtaining information on a length of the document;
reversing feeding direction of the document;
returning the document to an upper stream of a image reading unit corresponding to a length of the document; and
reading another face of the document as face-reversed.
